(19) United States
(12) Patent Application Publication
(10) Pub. No.: US 2019/0017609 A1
(43) Pub. Date: Jan. 17, 2019

(54) PROCESS VALVE AND FOOD TREATMENT AND/OR FILLING PLANT

(71) Applicant: EVOGUARD GMBH, Nittenau (DE)

(72) Inventor: Johann JUSTL, Sinzing (DE)

(21) Appl. No.: 16/032,607

(22) Filed: Jul. 11, 2018

(30) Foreign Application Priority Data
Jul. 12, 2017 (DE) 10 2017 211 905.5

(51) Int. Cl. F16K 1/44; F16K 49/00; B67C 3/00; B67C 3/26

(52) U.S. Cl. CPC F16K 1/446; F16K 49/007; B67C 3/2617; B67C 3/001; B67C 3/007

(57) ABSTRACT

In a process valve P comprising a housing, which defines first and second seats on both sides of an intermediate chamber and which is connected to product lines and comprises a closing element with a metallic shaft and first and second valve disks having surfaces that face the product lines the surface of at least one valve disk is thermally decoupled from the valve disk to a very large extent. The process valve P with the thermal decoupling unit is installed in a node of a food treatment and/or filling plant.

### CROSS-REFERENCE TO RELATED APPLICATION

This application claims priority to German Patent Application No. 10 2017 211 905.5 entitled “PROCESS VALVE AND FOOD TREATMENT AND/OR FILLING PLANT,” filed on Jul. 12, 2017, the entire contents of which is hereby incorporated by reference in its entirety for all purposes.

### TECHNICAL FIELD

The present disclosure relates to a process valve, a use of a process valve in a food treatment and/or filling plant, as well as to a food treatment and/or filling plant.

### BACKGROUND AND SUMMARY

An example of a process valve of the type referred to at the beginning and known in practice will be explained on the basis of FIG. 1.

The first valve disk 10 comprises an exposed surface 23, which faces the product line 2 and which is provided with a central projection 24 (e.g. as a screw handle), as well as an annular surface 26 exposed in the intermediate chamber Z. The second valve disk 12 comprises an exposed annular second surface, which faces the second product line 3 in the housing chamber 4, as well as an exposed surface 27 in the intermediate chamber Z. When the process valve P according to FIG. 1 is used for processing a foodstuff, such as milk, in a node N of a food treatment and/or filling plant A and when the intermediate chamber Z is cleaned and sterilized, respectively, at the closed position with a pressurized, heated medium introduced therein, the shaft 9 and the first valve disk 10 will increasingly collect heat, which is transferred up to and into the exposed surface 23 facing the first product line 2, whereby said surface 23 will be heated increasingly. Due to the fact that the surface 23 is heated, the product, e.g. milk, contained in the first product line 2 tends to adhere and stick to the surface 23. The layer (burn-on) settling on the surface 23 necessitates, e.g. after a predetermined step running time, a so-called CIP (Cleaning In Place) cleaning cycle for cleaning the components in the process valve and for eliminating the burn-on on the surface 23. Due to the heating of the surface 23 and the burn-on, the step running time between cleaning cycles will be reduced and, in certain cases, it will even be necessary to manually intervene in the cleaning process. The resultant high frequency of possibly more complicated cleaning cycles is inefficient.

Even though EP 3106633 A1 suggests to thermally relieve the stem of hollow poppet valves during valve operation of an internal combustion engine through insulating layers or fillings relative to the combustion chamber, this has no bearing on food products and the hygienically unobjectionable treatment of the latter.

It is the object of the present disclosure to improve such a process valve with respect to the lowest possible frequency of necessary cleaning cycles and to provide a food treatment and/or filling plant whose operation at a node formed between product lines and comprising the process valve allows long step running times between cleaning cycles.

In view of the fact that the exposed valve disk surface facing the product line is thermally decoupled from the valve disk, the surface will heat up significantly less during operation and a product in the product line will substantially less tend to adhere to and/or form a burn-on on the valve disk. The step running time between the cleaning cycles can thus be extended e.g. approximately by a factor of 4. In addition, deposits occurring in minimized amounts during the step running time can easily be removed in a CIP cleaning cycle without manual intervention.

The node provided with the process valve according to the present disclosure can be operated in the food treatment and/or filling plant with substantially longer step running times, whereby the efficiency of the plant can be increased significantly.

According to an embodiment, the thermally decoupled surface is arranged on a cover cap facing the product line, said cover cap being secured in position in the valve disk and delimiting together with the valve disk a chamber containing e.g. air. The chamber and the air contained therein reduce significantly the heating up of the cover cap surface facing the product in the product line. Instead of air, the chamber may contain some other thermally insulating medium.

According to an embodiment, at least the surface of the valve disk facing the product line which contains a product most of the time is thermally decoupled at the cover cap through the chamber. However, it is possible to thermally decouple in the same way also a surface of the second valve disk, which faces the second product line, so as to minimize deposits also there. Even the surfaces of the first and second valve disks, which are located in the intermediate chamber, can be thermally decoupled in an analogous manner.

It will be advantageous when the chamber is delimited by a substantially planar bottom of a reception recess defining part of the valve disk and positioning the cover cap and a substantially planar bottom of the cover cap such that it has an approximately constant depth and an outer diameter that is slightly smaller than the inner diameter of the seat. It is even imaginable to thermally decouple the entire surface, although a narrow circular ring surface of the surface of the valve disk, which may perhaps heat up more than the surface of the cover cap, will not take up major deposits, not least in view of the fact that it is located in an area subjected to a strong self-cleaning flow dynamics during opening of the seat.

In order to prevent an undesirable pressure build-up in the air within the chamber, it will be expedient when the valve disk comprises at least one passage to the chamber, said passage allowing a pressure compensation, e.g. to the area of the intermediate chamber.

In order to allow the first and the second valve disk to be axially displaced independently of one another, it will be expedient when the second valve disk is, by means of a hollow tube, guided on the shaft in an axially displaceable manner.

For the purpose of flushing or sterilizing, e.g. by means of superheated steam, it will, finally, be expedient when at least one connection of a media valve opens into the intermediate chamber, possibly even two, approximately diametrically opposed, connections of two media valves.

Making reference to the drawing, an embodiment of the subject matter of the present disclosure shown in FIG. 2 will be explained.

### BRIEF DESCRIPTION OF FIGURES

FIG. 1 shows a longitudinal section of a process valve known in practice, said process valve occupying the closed position.

FIG. 2 shows a longitudinal section analogous to FIG. 1 of an embodiment of a process valve according to the present disclosure, said process valve occupying the closed position and being installed at a node in a food treatment and/or filling plant between product lines.

### DETAILED DESCRIPTION OF THE FIGURES

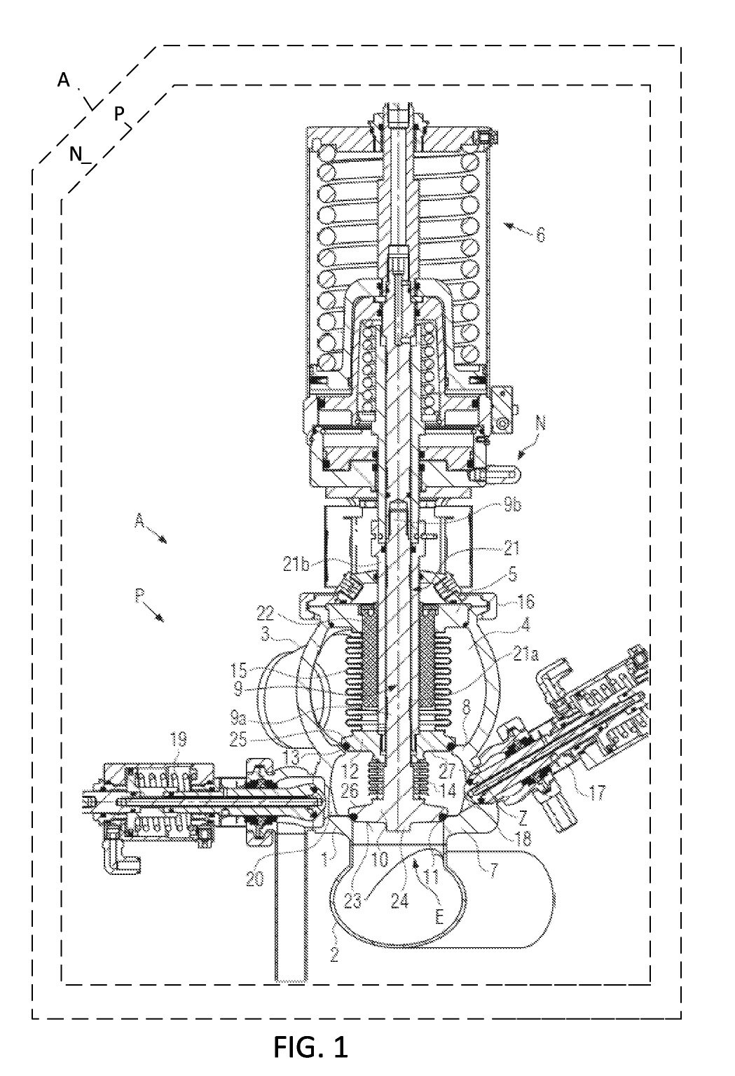

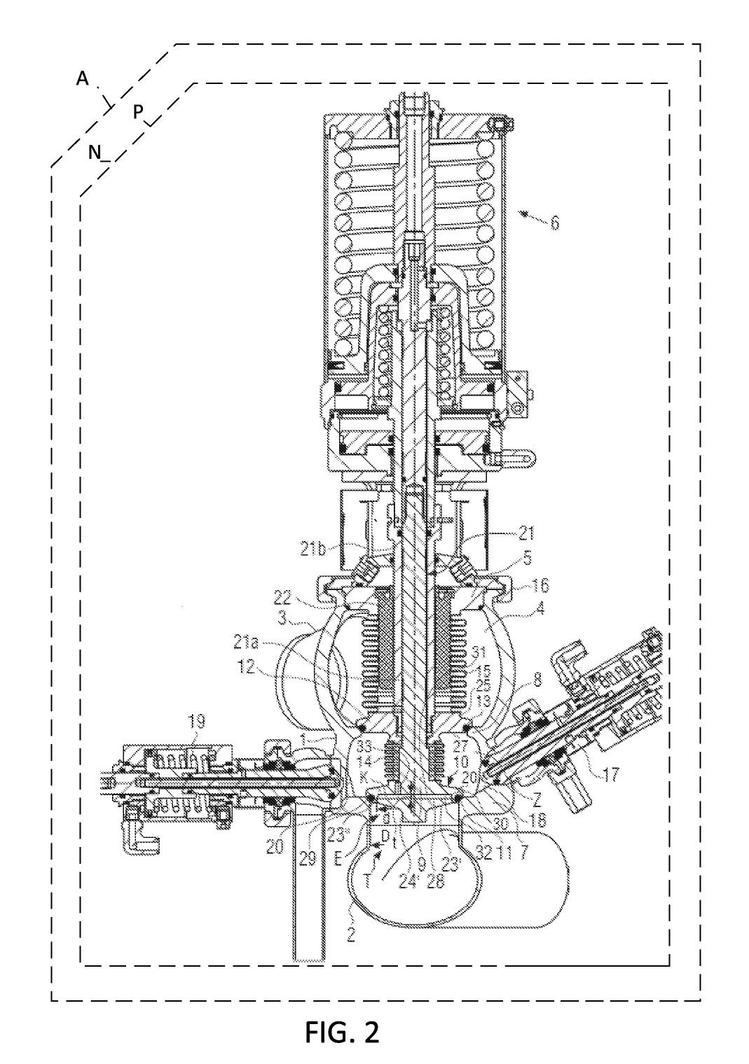

In FIG. 2, the components of the embodiment of the process valve P according to the present disclosure corresponding to the components according to FIG. 1 are identified by the same reference numerals as in FIG. 1. The process valve P has a metallic housing 1, which defines seats 7, 8 arranged on both sides of an intermediate chamber Z and which, on the side facing away from the intermediate chamber Z, is connected to first and second product lines 2, 3 on both sides. The second product line 3 is here connected to a housing chamber 4, which is closed on the side facing away from the intermediate chamber Z by means of a closure unit 5. There, a process valve actuator 6 having a conventional structural design is attached via a clamping ring 16. The housing 1 contains a metallic closing element E comprising first and second valve disks 10, 12 on an axially installed shaft 9, the first valve disk 10 being integral with the shaft 9, whereas the second valve disk 12 is guided on this shaft such that it is axially displaceable relative thereto. The first and second valve disks 10, 12 cooperate alternatively with the seats 8, 7 via seals 13, 11, so as to separate, at the closed position shown in FIG. 1, the first and second product lines 2, 3 from one another and form the intermediate chamber Z, so as to interconnect, at the open position, the first and second product lines 2, 3 via the intermediate chamber Z, or so as to connect the intermediate chamber Z to the housing chamber 4 in the raised condition of the second valve disk 12 or the intermediate chamber Z to the first product line 2 in the raised condition of the first valve disk 10. A section 9a of the shaft 9 inside the intermediate chamber Z is sealingly encompassed by a first bellows 14 with a certain amount of radial play, said first bellows 14 being secured in position on the first and second valve disks 10, 12 and containing e.g. air. A section 9b of the shaft 9 in the housing chamber 4 is sealingly encompassed by a second bellows 15 with a certain amount of radial play, said second bellows 15 being secured in position on the closure unit 5 and the second valve disk 12 and containing e.g. air. At least one connection 18, 20 of a media valve 19, 17 opens into the intermediate chamber Z. In the embodiment shown, two opposedly placed media valves 19, 17 and two opposedly placed connections 18, 20 to the intermediate chambers are provided, by means of which the intermediate chamber Z and the components of the closing element E located therein can be cleaned with a medium introduced under pressure and temperature, and the intermediate chamber Z can be sterilized, e.g. by means of superheated steam. On the shaft 9 a hollow tube 21 is displaceably guided, a lower portion 21a of which is connected to the second valve disk 12 and an upper portion 21b of which leads, via another hollow tube, into the process valve actuator 6. The latter is capable of actuating the valve disks 10, 12 relative to one another and relative to the seats 7, 8. The hollow tube 21 is encompassed by a tubular support body 22 along a part of the section 9b of the shaft 9 within the second bellows 15. Details of the solution according to the present disclosure in FIG. 2 which differ from the known process valve in FIG. 1 are emphasized by different reference numerals.

The process valve P according to the present disclosure shown in FIG. 2 is installed e.g. in a schematically illustrated node N of a food treatment and/or filling plant A, is not shown schematically by dotted lines, between the first and the second product line 2, 3, the process valve P being installed at a position where the process valve actuator 6 is located at the top and the first product line 2, from which a product is transferred to the second product line 3 at the open position, is located at the bottom. The process valve P need not be installed precisely vertically, but may be positioned obliquely, or it may be operated from below.

Other than the known process valve in FIG. 1, the process valve P according to the present disclosure in FIG. 2 exhibits for the first valve disk 10 a different concept with a thermal decoupling unit T, e.g. for the exposed valve disk surface 23′, 24′ facing the first product line 2, so that the surface 23′, 24′ will heat up less when the intermediate chamber Z is acted upon by heat and so that a deposition of product or a burn-on on the surface 23′, 24′ will be minimized significantly.

The thermal decoupling unit T in FIG. 2 is defined by an approximately plate-shaped cover cap K, which consists e.g. of the same steel material as the closing element E itself, said cover cap K being secured in position, e.g. by means of welding, in a reception recess 30 of the first valve disk 10 and defining together with said first valve disk 10 a chamber 32, which is here circular in shape and which contains e.g. air. The chamber 32 is delimited at the bottom by an approximately planar bottom 28 of the cover cap K, towards the outer side by a circumferential wall of the reception recess 30, at the top by a substantially planar bottom 31 of the reception recess 30, said bottom 31 extending e.g. parallel to the bottom 28. The depth t of the chamber 32 may be approximately constant. In an alternative embodiment, a lens-shaped cross-section or a differently configured cross-section of the chamber 32 may be used. The outer diameter d of the chamber 32 is e.g. slightly smaller than the inner diameter D of the seat 7 in the housing 1, so that, if at all, only a narrow circular ring surface 23″ of the first valve disk 10 faces the product line 2, whereas the surface 23′, 24′ facing the product line 2 is thermally decoupled from the valve disk 10 to a large extent. In order to prevent pressure from building up in the chamber 32, a passage 33 in the valve disk 10 may connect the chamber 32 to the interior of the bellows 14.

Although this is not shown in FIG. 2, also the surface 25 of the second valve disk 12, which faces the product line 3, may be provided with an analogous thermal decoupling unit T, or even the surface 27 and/or the surface 26 of the first and second valve disks 10, 12 may thermally be decoupled in an analogous manner.

When the intermediate chamber Z is sterilized, e.g. with superheated steam, the respective surface, which is thermally decoupled from the valve disk and which faces e.g. the product line 2 or 3, will heat up only to a minor extent. This also applies to a cleaning cycle, in which a cleaning medium is introduced under pressure into the intermediate chamber separated from a product line, and deposits are removed, with the second valve disk 12 being e.g. raised from the seat 8.

1. A process valve for a food treatment and/or filling plant comprising a housing, which defines axially spaced first and second seats on both sides of an intermediate chamber that is adapted to be at least thermally acted upon from outside, said housing being connected to first and second product lines on sides of the seats facing away from the intermediate chamber, and further comprising an axially displaceable closing element having a shaft and first and second valve disks, which cooperate alternatively with the seats and which have exposed surfaces facing at least the product lines, wherein at least the surface of at least one valve disk or, which faces a product line, is thermally decoupled from the valve disk to a large extent.

2. The process valve according to claim 1, wherein the thermally decoupled surface is arranged on a cover cap facing the product line, said cover cap being secured in position in the valve disk and delimiting as a thermal decoupling unit together with the valve disk a chamber containing a thermally insulating medium.

3. The process valve according to claim 1, wherein each valve disk has at least one of its surfaces thermally decoupled.

4. The process valve according to claim 2, wherein the chamber is delimited by a substantially planar bottom of a reception recess defining part of the valve disk and positioning the cover cap and a substantially planar bottom of the cover cap such that it has an approximately constant depth and an outer diameter that is slightly smaller than the inner diameter of the neighbouring seat.

5. The process valve according to claim 2, wherein the valve disk comprises at least one pressure compensation passage to the chamber.

6. The process valve according to claim 1, wherein the shaft is outwardly sealed off from the intermediate chamber in a section of the intermediate chamber and between the first and second valve disks by a first bellows secured in position on the valve disks or on the shaft.

7. The process valve according to claim 1, wherein a hollow tube on the shaft extends axially through a housing chamber, which is connected to the second product line, and a closure area of the housing into a process valve actuator installed on the housing, and that in the housing chamber a second bellows seals the hollow tube off from the outside between the second valve disk or the hollow tube and the closure area.

8. The process valve according to claim 1, wherein the second valve disk is guided on the shaft in an axially displaceable manner by the hollow tube.

9. The process valve according to claim 1, wherein at least one outlet of a media valve opens into the intermediate chamber.

10. A food treatment and/or filling plant including a process valve comprising a housing, which defines axially spaced first and second seats on both sides of an intermediate chamber that is adapted to be at least thermally acted upon from outside, said housing being connected to first and second product lines on sides of the seats facing away from the intermediate chamber, and further comprising an axially displaceable closing element having a shaft and first and second valve disks, which cooperate alternatively with the seats and which have exposed surfaces facing at least the product lines, wherein at least the surface of at least one valve disk or, which faces a product line, is thermally decoupled from the valve disk to a large extent, and the process valve is installed in a node between the first and second product lines.
